(19) United States
(12) Patent Application Publication
(10) Pub. No.: US 2007/0055043 A1
(43) Pub. Date: Mar. 8, 2007

(54) Modified polyethylene, terephthalate for low temperature dyeability, controlled shrinkage characteristics and improved tensile properties

(76) Inventors: Vikas Madhusudan Nadkarni, Maharashtra (IN); Anjan Kumar Mukhopadhyay, Maharashtra (IN); Ashwin Kumar Jain, Maharashtra (IN); Manoj Jhaver, Maharashtra (IN)

Correspondence Address: MORRISON & FOERSTER LLP, 1650 TYSONS BOULEVARD, SUITE 300, MCLEAN, VA, 22102, US

(21) Appl. No.: 10/580,172

(22) PCT Filed: Nov. 18, 2004
(86) PCT No.: PCT/IN04/00358

§ 371 Date: May 22, 2006

(30) Foreign Application Priority Data
Nov. 21, 2003 (IN) 1202/MUM/2003

(51) Int. Cl. C08G 63/02

(52) U.S. Cl. 528/272

(57) ABSTRACT

The modified polyethylene terepthalate is a copolymer formed from terephthalic acid or its ester, ethylene glycol, a flexible long chain aliphatic dicarboxylic acid or its ester, and a hydroxy terminated polyether polyol or acyclic diol or aliphatic diol. The modified polyethylene terephthalate filament, staple fiber, yarn and resultant fabric is dyeable with a disperse dye without dye carrier at low temperature of about 100° C. The dyed filament, staple fiber, yarn and resultant fabric has a dye index greater than 100, and preferably at least about 120 to 600 with controlled shrinkage of 6 to 10%.

### RELATED APPLICATION

This application claims priority from India National patent application serial No.1202/MUM/2003, filed 21 Nov. 03.

### TECHNICAL FIELD

The present invention relates to modified polyethylene terephthalate polymers and fibers and method of manufacturing the same. The present invention further relates to Yarns and fabrics produced therefrom having low temperature dyeability with good dye fastness, improved tenacity and controlled shrinkage characteristics.

### BACKGROUND OF INVENTION

Polyester fibers are strong and lightweight and generally have good elastic memory. Polyester has long been recognized as a desirable material for textile applications. The basic processes for the manufacture of polyester are relatively well known and fibers from polyester can be appropriately woven or knitted to form textile fabric. Polyester fabrics resist wrinkles and retain their shape in use. Polyester fibers are often blended with cotton as well as other fibers to produce fabrics, which have the enhanced strength, durability and memory aspects of polyester, while retaining many of the desired qualities of the natural fiber with which the polyester is blended, particularly for clothing.

It has long been known that synthetic fibers such as polyester which are initially formed as extruded linear filaments will exhibit more of the properties of natural fibers such as wool or cotton if they are treated in some manner which changes the linear filament into some other shape. Such treatments are generally referred to in the art as texturizing, and can include false twisting, crimping and certain chemical treatments.

Unmodified polyethylene terephthalate (PET) fiber can generally only be dyed with disperse dyes at elevated temperatures of about 130° C. and under high-pressure. Such high temperatures and pressures require high temperature high-pressure (HTHP) dyeing equipment. The need for such specialized dyeing equipment is a principal reason for the limited usages of standard polyester fibers in hand looms and power loom sectors, where such HTHP dyeing equipment is generally not available.

It is also known in the art to improve the dyeability of polyester fibers by using a dye carrier. The use of a dye carrier, however, leads to poor color fastness, and the dye carrier is retained in the dye processing wastewater. This presence of the dye carrier in the wastewater effluent is a pollutant and is anti-environmental. The art desires a readily dyeable PET, particularly suitable in the handloom and power loom sectors of the industry, and which avoids the use of dye carrier.

According to prior art adipic acid is added to PET to produce a copolyester with improved dyeability. Dyeability of the copolyester increases with the increased amounts of adipic acid used during production. Adipic acid degrades at high temperature and hence polymerization temperature has to be slowed. Hence the quantity of adipic acid recommended in the prior art is not more than about 4 wt. % (based on the amount of terephthalic acid or its ester equivalent).

Prior art also reports the incorporation of pentaerythritol at low levels of less than from 175 to 700 parts per million (ppm) based on the weight of the terephthalic acid (TA) or dimethyl terephthalate (DMT) into PET for improved dyeability. However pentaerytliritol, at levels greater than about 700 ppm, often results in decreased strength of the fiber.

U.S. Pat. Nos. 5,135,697 and 5,272,246 disclose the incorporation of 175 to 700 ppm of pentaerytlritol and 1.3 to 3.1 wt. percent adipic acid based on the amount of TA or DMT in the PET. The combination of the addition of pentaerythritol, adipic acid and PET resulted in a copolymer with an improved atmospheric dye rating as compared to using adipic acid and PET, or pentaerythritol and PET combinations.

The major drawback of the prior art involving use of branching agent like pentaerychritol is it results in poor texturizing performance of partially drawn yarn (POY).

U.S. Pat. No. 6,284,864 describes a copolyester fiber and a method of producing a copolyester fiber with improved dyeability and dye retention properties. The method comprises a batch or continuous process of reacting TA or DMT and ethylene glycol in an esterification stage followed by a polycondensation stage, adding a mixture of Dibasic Esters (DBEs) and pentaerythritol to the reaction, extruding the resulting copolymer into a fiber.

Another additive reported in the prior art is polyethylene glycol (PEG), which improves antistatic properties and dyeing characteristics at the expense of tensile strength when incorporated with polyester into textile fibers. According to the prior art the negative characteristics introduced into the polyester fiber by incorporation of polyethylene glycol can be ameliorated by using poly ethylene glycol in conjunction with some other molecule or functional group which would concurrently enhance properties of the fiber.

U.S. Pat. No. 4,975,233 and U.S. Pat. No. 5,091,504 report manufacture of polyester fibers for textile applications. The method comprises forming a polyester-polyethylene glycol copolymer from a mixture consisting essentially of terephthalic acid or dimethylterephthalate, ethylene glycol and polyethylene glycol.

U.S. Pat. No. 4,049,621 discloses that polyester fibers enhanced with less than 6 weight percent polyethylene glycol do not exhibit acceptable dyeability without a carrier.

None of the prior techniques suggest that modification of polyester fiber with polyethylene glycol alone in amounts lower than about 5 percent can have any significant beneficial effect on the various desirable characteristics of a polyester fiber.

Occasionally polyethylene glycol has been used in the manufacture of polyester fiber in conjunction with other additives to compensate for the disadvantages introduced by those other additives.

JP200265328 describes a process for producing a modified polyester fiber enabling sufficiently deep dyeing under normal pressure with a disperse dye. The modified polyester fiber is produced by using a polyester copolymerized with a polyalkylene glycol by melt-spun at a temperature above the melting point of the polyester and below 300° C.

U.S. Pat. No. 6,294,254 discloses polyester modified with polyethylene glycol and pentaerythritol. In this patent the polyester composition includes polyethylene terephthalate, polyethylene glycol and chain branching agent in quantities sufficient to prepare a polyester composition that permits filament manufacture under substantially normal spinning conditions.

U.S. Pat. No. 6,454,982 describes a method of preparing polyethylene glycol modified polyester filaments comprising preparation of PEG-modified polyester, polymerizing in the solid phase until the copolyester is capable of achieving a melt viscosity sufficient to spin filaments.

U.S. Pat. No. 6,291,066 for polyethylene glycol modified polyester fibers and method for making the same describes copolymerizing polyethylene glycol and branching agent into polyethylene terephthalate in the melt-phase to form a copolyester composition having an intrinsic viscosity of at least about 0.67 dl/g. Thereafter, copolyester filaments can be spun from the copolyester composition.

A related method for making nonwoven fabrics formed from such enhanced polyester fibers is described in pending application Ser. No. 09/761,446, filed on Jan. 18, 2001 which describes copolymerizing polyethylene glycol and branching agent into polyethylene terephthalate in the melt-phase or, alternatively in the solid-phase, to form a copolyester composition, which is then formed into copolyester fibers. Thereafter, copolyester fibers are formed into nonwoven fabrics.

With the exception of U.S. Pat. No. 6,294,254, these commonly-assigned applications relate to copolyester compositions having relatively low amounts of branching agent (e.g., below about 500 ppm pentaerythritol). In contrast, U.S. Pat. No. 6,294,254 ‘relates to copolyester compositions including branching agents in an amount sufficient to raise the melt viscosity of the composition to a level that permits filament manufacture under conditions that are substantially the same as those under which filament can be formed from unmodified polyethylene terephthalate.

It is known to modify polyesters by polyethylene glycol (PEG). The PEG modified PET provides some improvement in dye uptake. Generally, polyethylene glycol modified polyethylene terephthalate provides copolymer polyester fibers, which cause difficulties in weaving and fabric finishing due to inferior tensile strength.

Nevertheless, there continues to be a need for improved copolyester fibers of PET that possess enhanced, superior dyeing properties, particularly at relatively low temperatures and atmospheric pressures, and also possess suitable characteristics of controlled shrinkage and tensile properties.

The present invention provides the solution to the aforesaid prior art needs.

### SUMMARY OF THE INVENTION

A modified polyethylene terphthalate copolymer comprising a terephthalic acid or its ester equivalent, an ethylene glycol, and a flexible long chain aliphatic dicarboxylic acid or its ester equivalent in which the molar ratio of ethylene glycol and PTA is 1 to 3.5 with 2 to 10 weight percent aliphatic dicarboxylic acid based on polymer PTA which further comprises a hydroxy terminated polyether polyol in which hydroxy terminated polyether polyol equivalent to 1 to 5 weight percent in the polymer or an aliphatic or alicyclic diol in which an aliphatic or alicyclic diol equivalent to 1 to 5 weight percent in the polymer.

A method for making a modified polyethylene terephthalate copolymer comprising preparing slurry of MEG and PTA in molar ratio of 1 to 3.5 with 2 to 10 weight percent aliphatic dicarboxylic acid based on polymer and charging the same in the Esterification reactor, esterifying under nitrogen pressure of 1 to 2 kg/cm²g and temperature 250° C. to 290° C., removing byproduct, water, and excess MEG by using separation tower, adding catalyst Sb₂O₃ (200 to 500 ppm Sb in polymer), the thermal stabilizer, H₃PO₄ (40 to 80 ppm P in polymer) and TiO₂ (0.04% in polymer) at the end of esterification, transferring the same to Polycondensation reactor under nitrogen pressure, carrying out polycondensation under vacuum and temperature around 250 to 290° C. and draining the polymer as strands.

A method for making a modified polyethylene terephthalate copolymer comprising reacting aliphatic dicarboxylic acid of 2 to 10-weight percent and PTA with an excess of MEG at temperature between 250 to 290° C., injecting additives like antimony trioxide (200-400 ppm), titanium dioxide (0.2-0.3%) and 1 to 4-weight percent of hydroxy terminated polyether polyol, into oligomer line before entering into the vacuum flashing stage; removing excess alkylene glycol, keeping the temperature of flasher between 265 to 290° C. and the vacuum in the range of 100 to 150 mm Hg, obtaining a low molecular weight poly(alkylene dicarboxylate) pre-polymer by maintaining the temperature in the Pre-polymerizer at 270 to 290° C. and the vacuum in the range of 10 to 30 mm Hg; removing any alkylene glycol remaining in the reaction mass and producing high molecular weight polyester at 270 to 290° C. at a vacuum level of 0.1 to 3.0 mm Hg.

The method is continuous or batch polymerization.

A copolymer fiber comprising a terephthalic acid or its ester equivalent; an ethylene glycol; and a flexible long chain aliphatic dicarboxylic acid or its ester equivalent and a hydroxy terminated polyether polyol or an alipthatic or alicyclic diol.

The fiber is dyed with a dispersed dye without dye carrier at 100° C. to have a dye index greater than 100, at least about 120-600 and a controlled shrinkage of 6 to 10%.

A yarn comprising the fiber is dyed with a dispersed dye without dye carrier at 100° C. to have a dye index greater than 100, at least about 120-600 and a controlled shrinkage of 6 to 10%.

The yarn is drawn or twisted yarn spun from modified PET copolymer by POY or DT. A drawn and twisted copolymer modified PET dyed yarn comprising a dye index greater than 100, at least about 120-600 and a controlled shrinkage of about 6 to 10%. The yarn is used to produce woven or knitted fabric.

A woven or knitted fabric comprising drawn and twisted copolymer modified PET yarns comprising a dispersed dye, said dyed fabric comprising a dye index of at least about 120-600.

### DESCRIPTION OF THE INVENTION

According to the present invention, the method of preparing modified copolyester filaments includes copolymerizing hydroxy terminated polyether polyol and long chain aliphatic dicarboxylic acid into polyethylene terephthalate in the melt phase to form a copolyester composition. As will be understood by those having ordinary skill in the art, such copolymerizing may be conventionally achieved by reacting ethylene glycol and either terephthalic acid or (e.g.) dimethyl terephthalate in the presence of dicarboxylic acid, and the hydroxy terminated polyether polyol. Continuous polymerization is also within the purview of the present invention.

The copolymer of the present invention comprises a terephthalic acid or its ester equivalent in combination with an ethylene glycol, a flexible long chain aliphatic dicarboxylic acid or its ester equivalent and a hydroxy terminated polyether polyol or other aliphatic or alicyclic diol. The copolymerization of these monomers may be carried out in a batch polymerization or in a continuous polymerization in the temperature range of 250° C. to 300° C., preferably in continuous polymerization.

Further filaments are melt spun from the co-polyester composition and converted into partially oriented yarn (POY) and fully drawn yarn (FDY) and optionally it is further texturised into DTY or FTTY and finally converted into fabric.

In addition, and importantly the resulting copolyester filaments may be dyed using disperse dyes at (low) temperature of about 100° C. (212° F.) and at atmospheric pressure.

The drawn novel copolyester fibers can be spun into yarn as 100% or it can also be blended with other kind of natural and synthetic fibers to form blended Yarns. In this regard, the drawn copolyester fiber is especially (suitable) for blending with cotton fibers, rayon fibers, polypropylene fibers, acetate fibers, nylon fibers, spandex fibers, conventional polyester fibers. The fabric can then be manufactured using various combinations of copolyester yarn either as 100% or in blends with other natural and synthetic fibers.

Filament or yarn or fabric is dyed with dispersed dye at 100° C. without carrier to have dye index greater than 100, at least about 120-600 and a controlled shrinkage of 6 to 10%.

The polymer composition is spun tow and drawline processed into drawn tow or staple fibers. Further staple fibers are melt spun into yarn.

The drawn novel copolyester staple fibers can be spun into yarn as 100% or can also be blended with other kind of natural and synthetic fibers to form blended Yarns. In this regard, the drawn copolyester staple fiber is especially (suitable) for blending with cotton fibers, rayon fibers, polypropylene fibers, acetate fibers, nylon fibers, spandex fibers, conventional polyester fibers. The fabric can then be manufactured using various combinations of copolyester yarn either as 100% or in blends with other natural and synthetic fibers.

Staple fibers or yarn or fabric is dyed with dispersed dye at 100° C. without carrier to have dye index greater than 100, at least about 120-600 and a controlled shrinkage of 6 to 10%.

According to present invention, one of the embodiments uses batch polymerization technique followed by downstream processing to produce partially oriented yarn (POY) and draw twisted yarn (DT). This product leads to easy dyeability with an optimum balance of dyeability and physical properties.

The process comprises preparing slurry of MEG and PTA in molar ratio of 1 to 3.5 with 2 to 10-weight percent aliphatic dicarboxylic acid based on polymer and charging the same in the Esterification reactor. The reaction was carried out under nitrogen pressure of 1 to 2 kg/cm²g and temperature was increased to 250° C.-290° C. During the esterification process, the byproduct, water, and excess MEG were removed by using separation tower, which is then cooled and recovered. After the end of the esterification, catalyst Sb₂O₃ (200 to 500 ppm Sb in polymer), the thermal stabilizer, H₃PO₄ (40 to 80 ppm P in polymer) and TiO₂ (0.04% in polymer) were added and then material was transferred to Polycondensation reactor under nitrogen pressure.

Vacuum was applied slowly to the Polycondensation reactor and a final vacuum of around 1 mm Hg was obtained in 45 minutes. The temperature was gradually increased to around 250 to 290° C. After polymerization was over, the reactor was pressurized with nitrogen and polymer was drained as strands and quenched in water bath. The strands were then cut into chips in a pelletizer. The copolyester chips were melt spun in a spinning machine in the form of POY with the following process conditions:

Denier/Filaments: 200/72

Spinning Temperature: 180 to 320° C.

Spinning Speed: 1800 to 3000 m/min

Quench air temperature: 10 to 25° C.

The mechanical properties of POY were compared with the conventional product and shown in Table I

TABLE I
Mechanical properties of POY

| | | Copolyester yarns | | | | | |
|---|---|---|---|---|---|---|---|
| | | | | Draw | Standard Polyester yarns | | |
| | | Tenacity | % | Force | Tenacity | % | Draw |
| Sr. No. | Denier | (gpd) | Elongation | (gm) | (gpd) | Elongation | Force (gm) |
| 1 | 200 | 2.25 | 120.6 | 70.4 | 2.8 | 129.5 | 82 |

The POY of polyester was then draw twisted by DT machine into 1.6 dpf with the following process conditions:

Denier/Filaments: 120/72

DT machine speed: 400 to 900 m/min

Draw ratio: 1.5 to 2.0

First Heater temperature: 60 to 90° C., Second heater temperature: 100 to 150° C.

The % shrinkage was in the range of 6% to 10%. The above yarns were made into knitted hose and dyed with Foron Blue SBGL at boiling water temperature (100° C.) for about 45 min, without using any dye carrier. The dyed hose samples were measured for color strength and their dyeability with conventional product was compared.

The strength and dyeability of the copolyester draw twisted yarn of the present invention compared with conventional polyester yarns are shown in Table II.

TABLE II
Mechanical properties of draw twisted yarns (DT)

| | | Copolyester yarns | | Standard Polyester yarns | |
|---|---|---|---|---|---|
| Sr. | | Tenacity | | Tenacity | |
| No. | Denier | (gpd) | % Elongation | (gpd) | % Elongation |
| 1 | 120 | 4.2 | 35.4 | 3.28 | 36.2 |

Dyeability Characteristics of draw twisted yarns (DT)

| | | Copolyester yarns | Standard Polyester yarns |
|---|---|---|---|
| Sr. No. | Denier | Dye Index | Dye Index |
| 1 | 120 | 350 | 100 |

According to present invention, another embodiment involves the use of Batch polymerization technique followed by downstream processing to produce POY and draw twisted yarn (DT). This product leads to easy dyeability with an optimum balance of dyeability and physical properties.

The batch process comprises preparing slurry of MEG and PTA in molar ratio of 1 to 3.5 with 2 to 10 weight percent aliphatic dicarboxylic acid based on polymer and charging the slurry in the Esterification reactor (EI). The reaction was carried out under nitrogen pressure of 1 to 2 kg/cm²g and temperature was increased to 250° C. to 290° C. During the esterification process, the byproduct, water, and excess MEG were removed by using separation tower, which was then cooled and recovered. After the end of the esterification, the catalyst Sb₂O₃ (200-500 ppm Sb in polymer), hydroxy terminated polyether polyol equivalent to 1 to 5 weight percent in the polymer, the thermal stabilizer, H₃PO₄ (40-80 ppm P in polymer) and TiO₂ (0.04% in polymer) were added and then material was transferred to polycondensation reactor under nitrogen pressure.

Vacuum was applied slowly to the Polycondensation reactor and a final vacuum of around 1 mm Hg was obtained in 45 min. The temperature was gradually increased to around 250-290° C. After the polymerization was over, the reactor was pressurized with nitrogen and polymer was drained as strands and quenched in water bath. The strands were then cut into chips in a pelletizer. The copolyester chips were melt spun in a spinning machine in the form of POY with the following process conditions:

Denier/Filaments: 200/72

Spinning Temperature: 180 to 320° C.

Spinning Speed: 1800 to 3000 m/min

Quench air temperature: 10 to 25° C.

The mechanical properties of POY were compared with the conventional yarns and shown in Table III.

TABLE III
Mechanical properties of POY

| | | Copolyester yarns | | | | | |
|---|---|---|---|---|---|---|---|
| | | | | Draw | Standard Polyester yarns | | |
| | | Tenacity | % | Force | Tenacity | % | Draw |
| Sr. No. | Denier | (gpd) | Elongation | (gm) | (gpd) | Elongation | Force (gm) |
| 1 | 200 | 2.4 | 144.3 | 54.3 | 2.8 | 129.5 | 82 |

The POY of polyester was then draw twisted by DT machine into 1.6 dpf with the following process conditions:

Denier/Filaments: 120/72

DT machine speed: 400 to 900 m/min

Draw ratio: 1.5 to 2.0

First Heater temperature: 60 to 90° C., Second heater temperature: 100 to 150° C.

The % shrinkage was in the range of 6% to 10%. The above yarns were made into knitted hose and dyed with Foron Blue SBGL at boiling water temperature (100° C.) for about 45 minutes, without using any dye carrier. The dyed hose samples were measured for color strength and their dyeability with conventional yarns was compared.

The strength and dyeability of the copolyester draw twisted yarn of the present invention were compared with conventional polyester yarns and are shown in Table IV.

TABLE IV
Mechanical properties of draw twisted yarns (DT)

| | | Copolyester yarns | | | |
|---|---|---|---|---|---|
| Sr. | | Tenacity | % | Standard Polyester yarns | |
| No. | Denier | (gpd) | Elongation | Tenacity (gpd) | % Elongation |
| 1 | 120 | 4.5 | 38.7 | 3.28 | 36.2 |

Dyeability Characteristics of draw twisted yarns (DT)

| | | Copolyester yarns | Standard Polyester yarns |
|---|---|---|---|
| Sr. No. | Denier | Dye Index | Dye Index |
| 1 | 120 | 375 | 100 |

According to present invention, yet other embodiment involves the use of Batch polymerization technique followed by downstream processing to produce staple fiber. This product leads to easy dyeability with an optimum balance of dyeability and physical properties.

Batch polymerization comprises preparing a slurry of MEG and PTA in molar ratio of 1 to 3.5 with 2 to 10 weight percent aliphatic dicarboxylic acid based on polymer and charging the slurry in the esterification reactor (EI). The reaction was carried out under nitrogen pressure of 1 to 2 kg/cm²g and temperature was increased to 250° C. to 290° C. During the esterification process, the byproduct, water, and excess MEG were removed by using separation tower, which is then cooled and recovered. After the end of the esterification, the catalyst Sb₂O₃ (200-500 ppm Sb in polymer), hydroxy terminated polyether polyol equivalent to 1 to 5 weight percent in the polymer, the thermal stabilizer, H₃PO₄ (40-80 ppm P in polymer) and TiO₂ (0.04% in polymer) were added and then material was transferred to Polycondensation reactor under nitrogen pressure.

Vacuum was applied slowly to the Polycondensation reactor and a final vacuum of around 1 mm Hg was obtained in 45 min. The temperature was gradually increased to around 250-290° C. After the polymerization was over, the reactor was pressurized with nitrogen and polymer was drained as strands and quenched in water bath. The strands were then cut into chips in a pelletizer. The entire downstream operation was carried out in a staple line.

The conditions maintained while spinning the fibers are as follows:

Denier: 1.2 and 1.0

Spinning Temperature: 200 to 280° C.

Spinning Speed: 1200 to 2000 in/min

Thereafter, tows were processed in the drawline keeping the following conditions:

Draw Bath temperature: 30 to 60 ° C.

Draw roll temperature: 30 to 70° C.

Annealer steam pressure: 12 to 15 kg/cm²

Total draw ratio: 2.5 to 3.8

Draw line speed: 50 to 100 m/min

The fibers were dyed with Foron Blue SBGL at boiling water temperature (100° C.) for about 30 min, without using any dye carrier. Mechanical Properties and dyeability data are summarized in Table V.

TABLE V
Mechanical Properties of fiber

| | | Copolyester fiber | | | | Standard Polyester fiber | | | |
|---|---|---|---|---|---|---|---|---|---|
| Sr. | | Tenacity | % | | | Tenacity | % | | % |
| No. | Denier | (gpd) | Elongation | T10 | % DHS | (gpd) | Elongation | T10 | DHS |
| 1 | 1.2 | 5.8 | 24.1 | 3.2 | 5.4 | 6.8 | 24 | 3.6 | 3.5 |
| 2 | 1.0 | 5.5 | 27.9 | 2.9 | 5.6 | 7.0 | 20 | 4.0 | 3.0 |

Dyeability Characteristics of fiber

| Sr. | | Copolyester fiber | Standard Polyester fiber |
|---|---|---|---|
| No. | Denier | Dye Index | Dye Index |
| 1 | 1.2 | 321 | 100 |
| 2 | 1.0 | 300 | 100 |

According to present invention, yet another embodiment involves the use of a novel continuous polymerization technique with optimization as to the location of addition, sequence of addition and the mode of addition of the comonomers so that the present invention can lead to the easy dyeability with an optimum balance of dyeability and physical properties.

In this technique of Continuous Polymerization, aliphatic dicarboxylic acid of 2 to 10-weight percent and PTA is reacted with an excess of MEG in four stages as follows: (1) The esterification stage during which at least 95% of the carboxylic acid groups are converted to the corresponding hydroxyalkylene ester group. The temperature of esterification is kept between 250 to 290° C.

Additives like antimony trioxide (200-400 ppm), titanium dioxide (0.2-0.3%) and 1 to 4-weight percent of hydroxy terminated polyether polyol, were injected into oligomer line before entering into the vacuum flashing stage.

(2) A vacuum flashing stage wherein a portion of the excess alkylene glycol that was introduced for the reaction in stage (1) was removed. The temperature of flasher was kept between 265 to 290° C. and the vacuum was kept in the range of 100 to 150 mm Hg.

(3) A pre-polymerization stage during which excess alkylene glycol from stage (1) was removed from the reaction mass to yield a low molecular weight poly(alkylene dicarboxylate) pre-polymer. The temperature in the Pre-polymerizer was kept at 270 to 290° C. and the vacuum was kept in the range of 10 to 30 mm Hg; and

(4) A finishing stage during which any alkylene glycol remaining in the reaction mass was removed and high molecular weight polyester was produced. The finisher temperature was kept at 270 to 290° C. at a vacuum level of 0.1 to 3.0 mm Hg.

The polymer from the finisher was fed to the Spinning machine and the entire downstream operation was carried out in a staple line.

The conditions maintained while spinning the fibers are as follows:

Denier: 1.4 and 1.0

Spinning Temperature: 200 to 290° C.

Spinning Speed: 1200 to 2500 m/min

Thereafter, tows were processed in the drawline keeping the following conditions:

Draw Bath temperature: 20 to 60° C.

Annealer steam pressure: 10 to 25 kg/cm²

Total draw ratio: 2.5 to 4.0

Draw line speed: 100 to 300 m/min

The dyeing was carried out using a disperse dye i.e., Foron Blue SBGL at boiling water temperature (100° C.) for about 45 minutes, without using a dye carrier. Mechanical Properties and dyeability data are summarized in Table VI.

TABLE VI
Mechanical Properties of fiber

| | | Copolyester fiber | | | | Standard Polyester fiber | | | |
|---|---|---|---|---|---|---|---|---|---|
| Sr. | | Tenacity | % | | | Tenacit-y | % | | % |
| No. | Denier | (gpd) | Elongation | T10 | % DHS | (gpd) | Elongation | T10 | DHS |
| 1 | 1.4 | 6.3 | 27.3 | 2.8 | 5.6 | 6.6 | 26 | 3.3 | 4.0 |
| 2 | 1.0 | 6.3 | 26.5 | 3.0 | 5.4 | 7.0 | 20 | 4.0 | 3.0 |

Dyeability Characteristics of fiber

| Sr. | | Copolyester fiber | Standard Polyester fiber |
|---|---|---|---|
| No. | Denier | Dye Index | Dye Index |
| 1 | 1.4 | 427 | 100 |
| 2 | 1.0 | 320 | 100 |

The copolymer fibers of the present invention may be blended with other fibers, including synthetic and natural fibers. In particular the copolymer fibers of the present invention may be blended with cotton, for making fabric used in the manufacture of clothing.

Typical examples are shown in Table VII.

TABLE VII
Woven Products from Easy Dyeable Fibers

| | Yarn count, Ne | | | | gms/sq. |
|---|---|---|---|---|---|
| Product Type | Warp | Weft | Ends/inch | Picks/inch | metre |
| Poplin and | 34s C* | 34s ED** | 82 | 52 | 105 |
| Dress materials | 34s ED | 34s C | 78 | 48 | 98 |
| Lungi and | 40s C | 40s ED | 72 | 72 | 105 |
| Handkerchief | 40s ED | 40s C | 72 | 72 | 105 |
| Furnishing and | 2/20s ED | 2/20s ED | 36 | 34 | 300 |
| Terry towel | | | | | |

Knitted Products from Easy Dyeable Fibers

| Product type | Count | Blend % | Gauge | gms/sq.m. | Style |
|---|---|---|---|---|---|
| T-Shirt | 40s | 100% ED | 24 | 150 | Single |
| | | | | | Jersey |

Note:
C*: cotton,
ED**: Easy dyeable

The PET-modified copolyester can be spun into partially oriented yarns (POY). As will be understood by those having ordinary skill in the art, POY is often comprised of from tens to hundreds of intermingled filaments (e.g., between 30 and 200) that are extruded from a spinneret at speeds typically between about 2000 and 4000 meters per minute. The POY is then typically drawn to form a drawn yarn, (e.g., by draw texturing, flat drawing, or warp drawing). Thereafter, the drawn yarn is formed into fabric, which is typically finished as well. As will be known by those skilled in the art, texturing can be effected in numerous ways, such as air jet, gear crimping, and false-twist techniques. The modified PET yarns of the present invention may be readily formed into fabrics on conventional handlooms and power looms.

Aliphatic dicarboxylic acid is selected from adipic acid, sebacic acid, azelaic acid, etc. Aliphatic or aromatic anhydrides are also used in copolymerization.

Hydroxy terminated polyether polyol or aliphatic or alicyclic diol is selected from polyethylene glycol (PEG), Monoethylene glycol (MEG), polypropylene glycol (PPG) etc.

It will be readily apparent to one skilled in the art that varying substitutions and modifications may be made to the invention disclosed herein without departing from the scope and spirit of the invention. Thus, it should be understood that although the present invention has been specifically disclosed by preferred embodiments and optional features, modification and variation of the concepts herein disclosed may be resorted to by those skilled in the art, and that such modifications and variations are considered to be falling within the scope of the invention.

The following examples are for the purpose of illustration of the invention only and are not intended in any way to limit the scope of the invention.

### EXAMPLE 1

Batch polymerization technique followed by downstream processing to produce POY and draw twisted yarn (DT). This product leads to easy dyeability with an optimum balance of dyeability and physical properties.

Slurry of MEG and PTA in molar ratio of 1.8 to 2.3 with 4 to 6 weight percent aliphatic dicarboxylic acid based on polymer was prepared and charged in the Esterification reactor. The reaction was carried out under nitrogen pressure of 1 to 2 kg/cm²g and temperature was increased to 250° C. to 290° C. During the esterification process, the byproduct, water, and excess MEG were removed by using separation tower, which was then cooled and recovered. After the end of the esterification, catalyst Sb₂O₃ (450 to 500 ppm Sb in polymer), the thermal stabilizer, H₃PO₄ (60 to 75 ppm P in polymer) and TiO₂ (0.04% in polymer) were added and then material was transferred to Polycondensation reactor under nitrogen pressure.

Vacuum was applied slowly to the Polycondensation reactor and a final vacuum of around 1 mm Hg was obtained in 45 minutes. The temperature was gradually increased to around 250 to 290° C. After polymerization was over, the reactor was pressurized with nitrogen and polymer was drained as strands and quenched in water bath. The strands were then cut into chips in a pelletizer. The copolyester chips were melt spun in a spinning machine in the form of POY maintaining the following process conditions:

Denier/Filaments: 200/72

Spinning Temperature: 180 to 320° C.

Spinning Speed: 1800 to 3000 m/min

Quench air temperature: 10 to 25° C.

The mechanical properties of POY were compared with the conventional product. The POY of polyester was then draw twisted by DT machine into 1.6 dpf maintaining the following process conditions:

Denier/Filaments: 120/72

DT machine speed: 400 to 900 m/min

Draw ratio: 1.5 to 2.0

First Heater temperature: 60 to 90° C., Second heater temperature: 100 to 150° C.

The % shrinkage was in the range of 6% to 10%. The above yarns were made into knitted hose and dyed with Foron Blue SBGL at boiling water temperature (100° C.) for about 45 minutes, without using any dye carrier. The dyed hose samples were measured for color strength and their dyeability with conventional product was compared.

The strength and dyeability of the copolyester draw twisted yarn of the present invention were compared with conventional polyester yarns.

### EXAMPLE 2

Batch polymerization technique followed by downstream processing to produce POY and draw twisted yarn (DT). This product leads to easy dyeability with an optimum balance of dyeability and physical properties.

Slurry of MEG and PTA in molar ratio of 1.8 to 2.3 with 4 to 6 weight percent aliphatic dicarboxylic acid based on polymer was prepared and charged in the Esterification reactor (EI). The reaction was carried out under nitrogen pressure of 1 to 2 kg/cm²g and temperature was increased to 250° C. to 290° C. During the esterification process, the byproduct, water, and excess MEG were removed by using separation tower, which was then cooled and recovered. After the end of the esterification, the catalyst Sb₂O₃ (400-450 ppm Sb in polymer), hydroxy terminated polyether polyol equivalent to 1.8 to 3 weight percent in the polymer, the thermal stabilizer, H₃PO₄ (60-75 ppm P in polymer) and TiO₂ (0.04% in polymer) were added and then material was transferred to Polycondensation reactor under nitrogen pressure.

Vacuum was applied slowly to the Polycondensation reactor and a final vacuum of around 1 mm Hg was obtained in 45 minutes. The temperature was gradually increased to around 250-290° C. After the polymerization was over, the reactor was pressurized with nitrogen and polymer was drained as strands and quenched in water bath. The strands were then cut into chips in a pelletizer. The copolyester chips were melt spun in a spinning machine in the form of POY maintaining the following process conditions:

Denier/Filaments: 200/72

Spinning Temperature: 180 to 320° C.

Spinning Speed: 1800 to 3000 m/min

Quench air temperature: 10 to 25° C.

The mechanical properties of POY were compared with the conventional product.

The POY of polyester was then draw twisted by DT machine into 1.6 dpf maintaining the following process conditions:

Denier/Filaments: 120/72

DT machine speed: 400 to 900 m/min

Draw ratio: 1.5 to 2.0

First Heater temperature: 60 to 90° C., Second heater temperature: 100 to 150° C.

The % shrinkage was in the range of 6% to 10%. The above yarns were made into knitted hose and dyed with Foron Blue SBGL at boiling water temperature (100° C.) for about 45 minutes, without using any dye carrier. The dyed hose samples were measured for color strength and their dyeability with conventional product was compared.

### EXAMPLE 3

Batch polymerization technique followed by downstream processing to produce staple fiber. This product leads to easy dyeability with an optimum balance of dyeability and physical properties.

Slurry of MEG & PTA in molar ratio of 1.8 to 2.3 with 4 to 6 weight percent aliphatic dicarboxylic acid based on polymer was prepared and charged in the Esterification reactor (EI). The reaction was carried out under nitrogen pressure of 1 to 2 kg/cm²g and temperature was increased to 250° C. to 290° C. During the esterification process, the byproduct, water, and excess MEG were removed by using separation tower, which was then cooled and recovered. After the end of the esterification, the catalyst Sb₂O₃ (400-450 ppm Sb in polymer), hydroxy terminated polyether polyol equivalent to 1.8 to 3 weight percent in the polymer, the thermal stabilizer, H₃PO₄ (60-75 ppm P in polymer) and TiO₂ (0.04% in polymer) were added and then material was transferred to Polycondensation reactor under nitrogen pressure.

Vacuum was applied slowly to the Polycondensation reactor and a final vacuum of around 1 mm Hg was obtained in 45 minutes. The temperature was gradually increased to around 250-290° C. After the polymerization was over, the reactor was pressurized with nitrogen and polymer was drained as strands and quenched in water bath. The strands were then cut into chips in a pelletizer. The entire downstream operation was carried out in a staple line.

The samples were spun maintaining the following conditions:

Denier: 1.2 and 1.0

Spinning Temperature: 200 to 280° C.

Spinning Speed: 1200 to 2000 m/min

Thereafter, tows were processed in the drawline keeping the following conditions:

Draw Bath temperature: 30 to 60 ° C.

Draw roll temperature: 30 to 70° C.

Annealer steam pressure: 12 to 15 kg/cm²

Total draw ratio: 2.5 to 3.8

Draw line speed: 50 to 100 m/min

The fibers were dyed with Foron Blue SBGL at boiling water temperature (100° C.) for about 30 minutes, without using any dye carrier.

### EXAMPLE 4

The continuous polymerization was carried out reacting aliphatic dicarboxylic acid of 4 to 6-weight percent and PTA with an excess of MEG in four stages. In the first stage, the temperature of esterification was kept between 250 to 290° C. Additives like antimony trioxide (200-400 ppm), titanium dioxide (0.2-0.3%) and 1.8 to 3-weight percent of hydroxy terminated polyether polyol, were injected into the oligomer line that was before the vacuum flashing stage.

In the vacuum flashing stage, a portion of the excess MEG that was introduced for the reaction in esterification was removed. The temperature of flasher was kept between 265 to 290° C. and the vacuum was kept in the range of 100 to 150 mm Hg. In the pre-polymerization stage, a low molecular weight poly (alkylene dicarboxylate) pre-polymer was formed. The temperature in the Pre-polymerizer was kept at 270 to 290° C. and the vacuum was kept in the range of 10 to 30 mm Hg. In the finishing stage, high molecular weight polyester was produced. The finisher temperature was kept at 270 to 290° C. at a vacuum level of 0.1 to 3.0 mm Hg.

The polymer from the finisher was fed to the Spinning machine and the entire downstream operation was carried out in a staple line.

The samples were spun maintaining the following conditions:

Denier: 1.4 and 1.0

Spinning Temperature: 200 to 290° C.

Spinning Speed: 1200 to 2500 m/min

Thereafter, tows were processed in the drawline keeping the following conditions:

Draw Bath temperature: 20 to 60° C.

Annealer steam pressure: 10 to 25 kg/cm²

Total draw ratio: 2.5 to 4.0

Draw line speed: 100 to 300 m/min

The dyeing was carried out using a disperse dye i.e., Foron Blue SBGL at boiling water temperature (100° C.) for about 45 min, without using a dye carrier.

The copolymer fibers of the present invention may be blended with other fibers, including synthetic and natural fibers. The copolymer as fibers of the present invention may be blended with cotton, particularly for making fabric used in the manufacture of clothing.

1. A polyethylene terphthalate-containing polymer formed by polymerizing a mixture comprising (a) terephthalic acid or an ester equivalent thereof, (b) a glycol, (c) an aliphatic dicarboxylic acid or an ester equivalent thereof, and (d) a hydroxy terminated polyether polyol,
wherein the mixture comprises: (1) a molar ratio of the glycol and the terepthalic acid of 1 to 3.5 (2) 2 to 10 weight percent of the aliphatic dicarboxylic acid based on the weight of the polymer; (3) the hydroxy terminated polyether polyol in an amount such that the hydroxy terminated polyether polyol is equivalent to 1 to 5 weight percent in the polymer; (4) the aliphatic or alicyclic diol in an amount such that the aliphatic or alicyclic diol is equivalent to 1 to 5 weight percent in the polymer.

2. A method for making a polyethylene terephthalate-containing polymer comprising:
preparing a mixture comprising a glycol and terephthalic acid or an ester equivalent thereof, wherein the mixture further comprises an aliphatic dicarboxylic acid
charging the mixture in a reactor;
esterifying the mixture under nitrogen pressure
adding a hydroxyl terminated polyether polyol, to the mixture;
and
carrying out a polycondensation reaction,
wherein the polymer is formed in a continuous polymer fiber manufacturing process.

3. A method for making a polyethylene terephthalate-containing polymer comprising:
polymerizing a mixture comprising an aliphatic dicarboxylic acid in an amount of 2 to 10-weight percent based on the weight of the polymer, a glycol and terephthalic acid or an ester equivalent thereof;
injecting 1 to 4-weight percent of a hydroxy terminated polyether polyol based on the weight of the polymer into the mixture;
obtaining a poly(alkylene dicarboxylate)-containing pre-polymer;
removing excess glycol from the mixture.

4. The method as claimed in claim 2, wherein the said method is a continuous or batch polymerization method.

5. The polymer as claimed in claim 1 wherein said aliphatic dicarboxylic acid is selected from the group consisting of adipic acid, sebacic acid, and azelaic acid.

6. The polymer as claimed in claim 1 wherein the hydroxy terminated polyether polyol or the aliphatic or alicyclic diol is selected from the group consisting of polyethylene glycol (PEG), Monoethylene glycol (MEG), and polypropylene glycol (PPG).

7. A filament comprising said polymer of claim 1.

8. The filament as claimed in claim 7, wherein said filament is dyed with dispersed dye without dye carrier to have a dye index greater than 100.

9. The filament as claimed in claim 7, wherein said dye index of said dyed filament is at least about 120-600.

10. The filament as claimed in claim 7, wherein a controlled shrinkage of said filament is 6 to 10%.

11. A yarn comprising said filaments as claimed in claim 7, wherein said yarn is POY or FDY.

12. The yarn as claimed in claim 11, wherein said yarn is optionally texturised to obtain DTY or FTTY.

13. The yarn as claimed in 11, wherein said yarn is dyed with a dispersed dye without dye carrier at 100° C. to have a dye index greater than 100.

14. The yarn as claimed in claim 11, wherein said dye index of said dyed yarn is at least about 120-600.

15. The yarn as claimed in claim 11, wherein said yarn has a controlled shrinkage of 6 to 10%.

16. A staple fiber comprising said polymer of claim 1.

17. The staple fiber as claimed in claim 16 wherein said staple fiber is dyed with a dispersed dye without dye carrier at 100° C. to have a dye index greater than 100.

18. The staple fiber as claimed in claim 16 wherein said dye index of said dyed yarn is at least about 120-600.

19. The staple fiber as claimed in claim 16, wherein said yarn has a controlled shrinkage of 6 to 10%.

20. A yarn comprising staple fibers as claimed in claim 16.

21. The yarn as claimed in claim 20, wherein said yarn is dyed with a dispersed dye without dye carrier at 100° C. to have a dye index greater than 100.

22. The yarn as claimed in claim 20, wherein said dye index of said dyed yarn is at least about 120-600.

23. The yarn as claimed in claim 20, wherein said yarn has a controlled shrinkage of 6 to 10%.

24. The yarn as claimed in claim 11, wherein said yarn is used to produce woven or knitted fabric.

25. A woven or knitted fabric comprising yarn as claimed in claim 11.

26. The fabric as claimed in claim 25, wherein said fabric is dyed with disperse dye without carrier to have a dye index greater than 100 and 6 to 10% controlled shrinkage.

27. (canceled)

28. The method of claim 2, wherein the glycol and the terephthalic acid or the ester equivalent thereof is in a molar ratio of 1 to 3.5, further wherein the mixture comprises 2 to 10 weight percent the aliphatic dicarboxylic acid based on the weight of the polymer and 1 to 5 weight % of the hydroxyl terminated polyether polyol based on the weight of the polymer.
